(19) United States
(12) Patent Application Publication
(10) Pub. No.: US 2004/0013086 A1
(43) Pub. Date: Jan. 22, 2004

(54) Device for controlling access between atm networks

(76) Inventors: Jean-Louis Simon, Lannion (FR); Pierre Rolin, Palaiseau (FR); Olivier Paul, Rennes (FR); Maryline Laurent Maknavicius, Courcouronnes (FR); Sylvain Gombault, Rennes (FR)

Correspondence Address: GARDNER CARTON & DOUGLAS LLP, 191 N. WACKER DRIVE, SUITE 3700, CHICAGO, IL, 60606, US

(21) Appl. No.: 10/333,862

(22) PCT Filed: Jul. 23, 2001
(86) PCT No.: PCT/FR01/02394

(30) Foreign Application Priority Data
Jul. 25, 2000 (FR) 00/09723

(51) Int. Cl. H04L 12/56

(52) U.S. Cl. 370/230; 370/395.2

(57) ABSTRACT

The device for access control between ATM networks, comprises signaling analysis means (4) and traffic analysis means (20, 21) linked to an ATM switch (3) configured so as to steer via the signaling analysis means, ATM signaling messages exchanged between internal and external ATM networks, and so as to steer via the traffic analysis means, traffic-bearing ATM cells exchanged between the internal and external networks within the framework of ATM connections established by means of said ATM signaling messages. Access control management means (7) dynamically configure the traffic analysis means (20, 21) as a function of an access control policy and of information gathered by the signaling analysis means (4) in such a way that the traffic analysis means filter each ATM cell in accordance with the access control policy.

The present invention relates to access control techniques within ATM networks (“Asynchronous Transfer Mode”).

The ATM technology has been specified so as to ensure the transport of streams of various kinds having varied requirements in terms of service quality (QoS, “Quality of Service”). The communications are connection orientated, being established, monitored and closed by means of a signaling protocol.

The invention aims to provide an access control tool for networks based on the ATM technology, that is to say networks used by ATM native applications and also by packet networks (for example IP or X25) for which the ATM technology is used in a transparent manner.

The quality of the access control performed in the networks is dependent on the amount of information which can be recovered in order to characterize the actions of users. Another important point is the ability of the access control tool to comply with the commitments as regards quality of service made by the network in relation to users. Since the access control procedures are heavy consumers of resources, it is necessary to make a compromise with regard to the amount of information which one wishes to recover while using as powerful as possible an information recovery and analysis procedure. Accordingly, the access control must be contrived in such a way as to adapt to the uses of the ATM network, dynamically.

The most obvious solution for carrying out access control in ATM networks is to use a firewall device between the network to be protected (hereinafter referred to as the internal network) and the unsafe pubic network (hereinafter referred to as the external network). This solution allows access control at the packet, circuit and application levels. In this case, the ATM network is regarded as a level 2 layer in the OSI model allowing the establishment of point-to-point connections. Two connections are established, one between the firewall and the internal equipment and the other between the firewall and the external equipment. With this type of tool, access control at the ATM level is not possible and the QoS associated with the ATM connections is not guaranteed.

At IP level and at circuit level, the IP packets are reassembled from the ATM cells and access control is carried out by means of the information contained in the headers of the IP packets (“Internet Protocol”, RFC 760, IETF, January 1980), TCP (“Transmission Control Protocol”, RFC 793, IETF, September 1981) and UDP (“User Datagram Protocol”) RFC 768, IETF, August 1980). The packets are filtered by comparing header fields, such as the source and destination ports and addresses, the direction of the packets and the TCP flags, etc., with a description of the permitted packets. The nonpermitted packets are destroyed while the permitted packets are transferred from one network to the other. When the same QoS is negotiated on either side of the firewall, end-to-end quality of service may be impaired as follows:

the reassembly, routing and fragmentation operations increase the cell transfer delay (CTD).

The operations performed on the information transmitted may increase the cell loss ratio (CLR).

The time taken to reassemble and fragment the packets is proportional to their size. The latter being variable, the jitter in the cell transfer delay (CDVT) may be modified.

The routing and filtering actions being done in a software manner, the system load may introduce modifications into the peak and average throughputs.

The actions at application level are filtered at application packet level by software called proxies. Just as at the IP and circuit levels, the QoS is disturbed, but to a greater extent since the traffic is examined at application level. Moreover, since filtering is generally done in a multitask environment, desynchronizations may occur between the filtered streams.

One final problem introduced by this type of architecture is its inability to support high throughputs. Several studies (ATM Net Management: Missing Pieces”, by J. Abusamra, Data Communications, May 1998 or “Firewall Shootout Test Final Report”, Keylabs, Networld+Interop '98, May 1998) have shown that this type of architecture was at present unable to provide the access control service in a satisfactory manner at the speed of an OC-3 link (155 Mbit/s).

The access control service as defined by the specifications of the ATM forum (“ATM Security Specification Version 1.0”, The ATM forum Technical Committee, February 1999) is an extension of the access control service as considered in the class A and B systems of the Orange Book. In this approach, a sensitivity level is associated with objects and a permission level is associated with subjects. Each level is coded by means of two types of parameter, on the one hand a hierarchical level (for example public, confidential, secret, highly secret, etc.) and on the other hand a set of domains (for example management, research, production, human resources, etc.). A subject can access an object if its hierarchical level is higher than that of the object and if at least one of the domains of the object is included in a domain of the subject.

In the specifications of the ATM forum, these two levels are coded in the form of labels according to the “Standard Security Labels for Information Transfer” standard (Federal Information Processing Standards Publication 188, National Institute of Standards and Technology, September 1994). The labels characterizing the sensitivity level of the data transmitted are exchanged before any exchange of user data by means of the ATM signaling or of a protocol of the user standpoint. Access control in itself is carried out by the network equipment which checks that the data sensitivity level is compatible with the level of permission of the links and of the interfaces over which the data are transferred.

The main advantage of this solution is its extendibility since the access control decision is made at the time the connection is opened and without interference with the user data. However, certain problems may be stressed:

all the equipment of the network is presumed to manage the security labels. Current equipment does not have such functionalities;

a connection must be established for each sensitivity level;

access control as considered in traditional firewalls (access to equipment, to services, etc.) is deliberately left out of the specifications.

The limitations described above have been rapidly identified and several proposals have been made in order to provide the access control service in its traditional sense in ATM networks. These solutions may be classified into two categories: industrial solutions and academic solutions.

The first type of industrial solution (“Lightstream 1010 Multiservice ATM Switch Overview”, Cisco Corp., 1999) uses a conventional ATM switch modified so as to filter the ATM connection requests as a function of the source and destination addresses. The main problem with this approach is that the access control service is not very powerful given the parameters considered.

The second industrial solution (“Atlas Policy Cache Architecture, White Paper”, B. Kowalski, Storagetek Corp., 1997) is also based on an ATM switch, modified so as to render an access control service at IP level. Instead of reassembling the cells so as to examine the headers of the packets as in a traditional firewall, this approach seeks to obtain this information directly from the first cell exchanged over a connection. This approach prevents disturbance to the quality of service during the switching of the cells. It also uses a CAM (“Content Addressable Memory”) associative memory so as to make the searches in the access control policy faster. This solution is the first to take account of the limits of the traditional firewall. However, it is not without defects:

the access control is limited to the network and transport levels. The ATM and application levels are not considered;

the IP packets which include options are not filtered at transport level. Indeed the options may dislodge the UDP and TCP related information into a second cell. This poses a security problem;

the equipment is difficult to manage in particular in the case of dynamic connections since the filters are configured manually;

the performance of this equipment is not very extendible. Indeed an OC-12 version (622 Mbit/s) of this product was announced in 1996, but has not been presented since.

The two academic solutions are based on the previous architecture but introduce improvements in order to fill in certain of the gaps in this solution.

The first approach (J. McHenry, et al., “An FPGA-Based Coprocessor for ATM Firewalls”, Proceedings of IEEE FCCM'97, April 1997) uses a special-purpose circuit of FPGA type associated with a modified switch. At ATM level, access control with establishment of connections is improved by allowing filtering based on the source and destination addresses. This solution also allows the filtering of PNNI (“Private Network to Network Interface”) routing information. At IP and transport levels, the access control service is similar to that of the second aforesaid industrial solution. This solution is the most complete currently deployed. However it has some limitations:

the IP packets with options are not processed;

only part of the information provided by the signaling is used;

there is no access control at application level.

The second academic solution (J. Xu, et al., “Design of a High-Performance ATM Firewall”, Technical report, The Ohio State University, 1997) is the most complete architecture proposed hitherto. A classification of the traffic into four categories is performed as a function of the QoS negotiated at ATM level and of the processing to be carried out on the stream. This classification makes it possible to ensure that the communications having quality of service constraints are not disturbed by complex processing operations, the other communications being filtered and disturbed in the same way as in a firewall. Apart from classification, this solution also introduces a whole set of interesting ideas for deployment to reduce the delays caused by access control. This approach nevertheless has certain drawbacks:

few parameters are considered at ATM level;

access control at application level is not provided for applications having QoS constraints;

UDP communications relying on ATM connections having QoS constraints are not controlled;

the architecture does not make it possible to eliminate information leaks since with outside complicity a user can foil the access control mechanisms;

the architecture is complex and one could ask what would be the throughputs supported by deploying this architecture.

A main aim of the present invention is to provide another solution to the problem of access control in ATM networks, which offers broad possibilities of control at various levels. Another aim is to facilitate the management of the access control tool by allowing in particular integration of various aspects of the access control policy at ATM, IP and transport levels. Yet another aim is to improve access control at ATM level by augmenting the access control parameters taken into consideration. It is also desirable to provide a fast access control service at cell level.

The invention thus proposes a device for access control between ATM networks, comprising signaling analysis means and traffic analysis means linked to an ATM switch configured so as to steer via the signaling analysis means, ATM signaling messages exchanged between internal and external ATM networks, and so as to steer via the traffic analysis means, traffic-bearing ATM cells exchanged between the internal and external networks within the framework of ATM connections established by means of said ATM signaling messages, the device furthermore comprising access control management means for dynamically configuring the traffic analysis means as a function of an access control policy and of information gathered by the signaling analysis means in such a way that the traffic analysis means filter each ATM cell in accordance with the access control policy.

Other features and advantages of the present invention will become apparent in the following description of nonlimiting exemplary embodiments, with reference to the appended drawings, in which:

FIG. 1 is a schematic diagram of an access control device according to the invention;

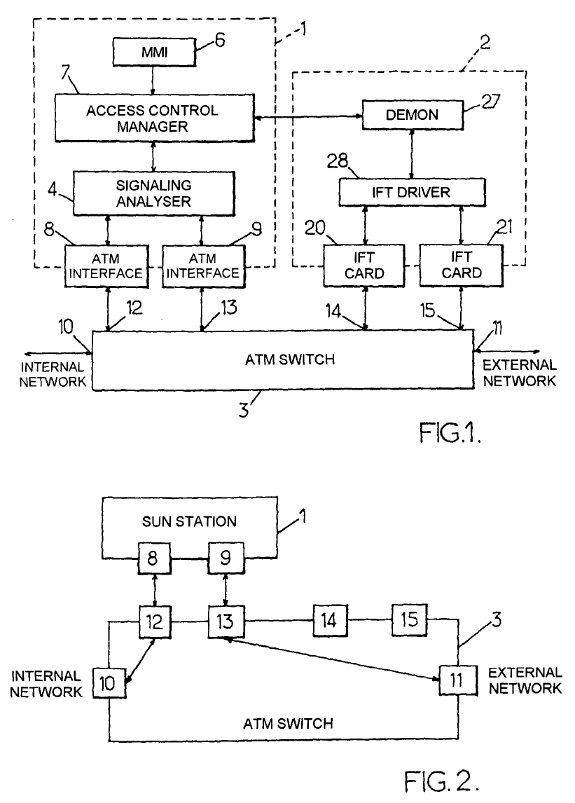

FIG. 2 is a layout illustrating a configuration of a switch of the device of FIG. 1 in relation to ATM signaling messages;

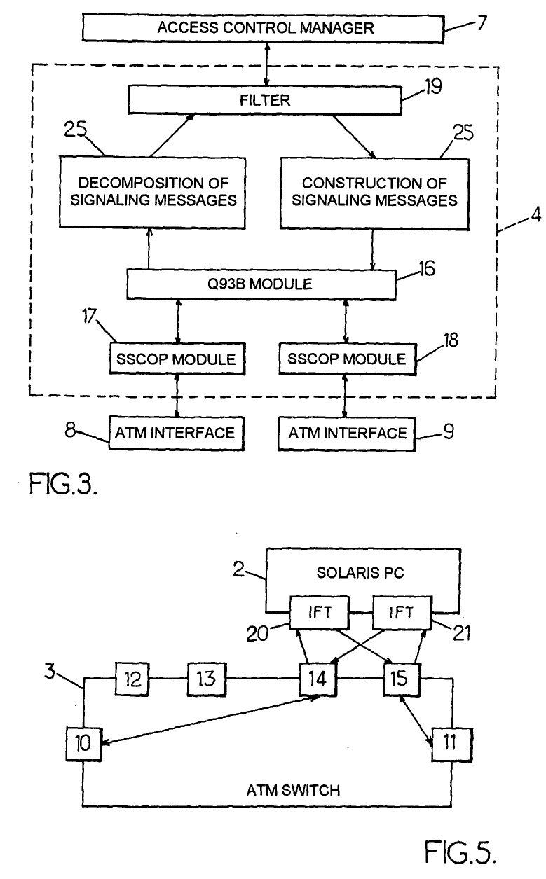

FIG. 3 is a schematic diagram of a signaling analyzer of the device of FIG. 1;

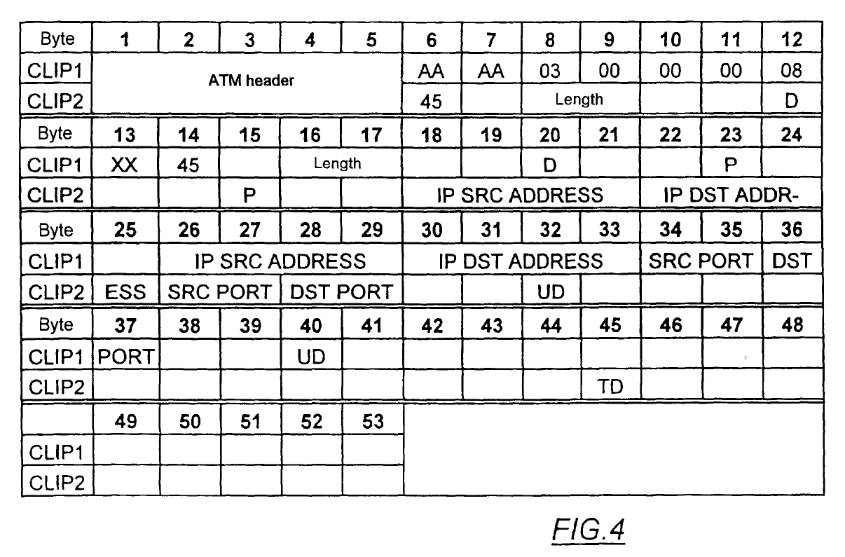

FIG. 4 is a table describing information processed by traffic analyzers of the device of FIG. 1;

FIG. 5 is a layout illustrating a configuration of the switch of the device of FIG. 1 in relation to ATM traffic cells; and

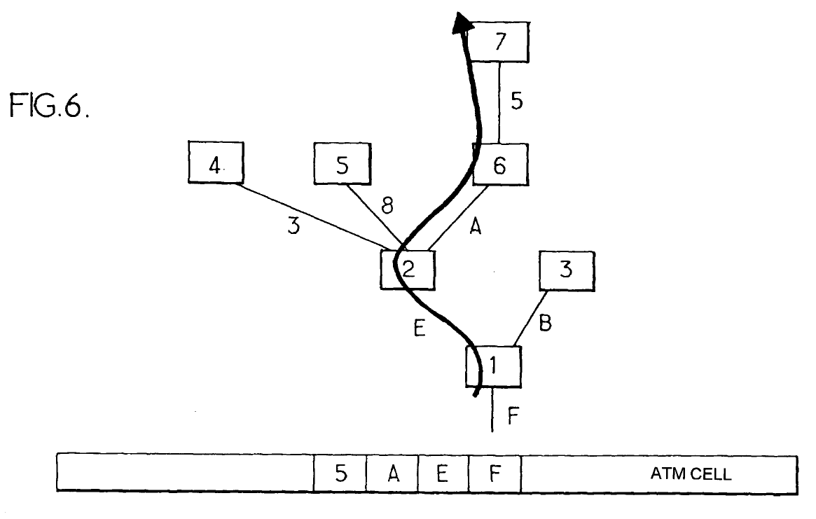

FIG. 6 is a layout illustrating an example of an analysis tree to which a traffic analyzer of the device of FIG. 1 refers.

As indicated in FIG. 1, an access control device according to the invention may be composed of two main parts 1, 2 cooperating with an ATM switch 3. The first part 1 is dedicated to the incorporation of an access control policy and to the analysis of ATM signaling. The result of this analysis is used to dynamically construct a configuration. The latter is used by the second part to provide an access control service based on the information transported in the ATM cells. This second part 2 is capable of recovering the ATM, IP and transport level information so as to decide whether a communication is to be permitted or disallowed. The assembly is configured by means of a unique language.

The part 1 can be embodied by means of a workstation, such as a station marketed by the company Sun Microsystem Inc. The signaling analyzer 4 is the element of this part 1 which performs the access control actions at the level of the ATM signaling in combination with the access control manager 7.

The part 2 can be embodied by means of a PC type station operating for example with the Solaris x86 operating system. This station is equipped with cards 20, 21 for real-time analysis of the ATM cells, hereinbelow referred to as IFT cards (“IP Fast Translator”) which undertake the cell-by-cell access control actions.

In order to write out access control policies, an Access Control Policy Definition Language (ACPDL, standing for “Access Control Policy Description Language”) is used. The definition of the ACPDL is based on the Policy Description Language (PDL) currently being defined within the working group working on policies at the IETF (see J. Strassner, et al., “Policy Framework Definition Language”, draftietf-policy-framework-pfdl-00.txt, Internet Engineering Task Force, 17 Nov. 1986). In this language, a policy is defined by a set of rules, each rule itself consisting of a set of conditions and an action which is executed when the set of conditions is fulfilled. The following expression (expressed in the Backus Naur formalism, BNF) describes the general form of a rule:

Rule::=IF<Conditions>THEN<Action>

All the conditions have the same generic structure expressed hereinbelow by means of the BNF formalism:

Condition::=<ACCESS CONTROL PARAMETER><RELATIONAL OPERATOR><VALUE>

As a function of the level in the protocol stack, several types of access control parameters may be used:

at ATM level, the interesting parameters are described in the article by O. Paul et al., “Manageable parameters to improve access control in ATM networks”, HP-OVUA Workshop, Rennes, France, April 1998. Among the latter, one may choose the type of traffic, the connection identifiers, the addressing information, the QoS descriptors and the service descriptors;

at transport level, most of the parameters considered are those which are customarily used in order to carry out the filtering of the packets in filtering routers (for example the addressing information, the source and destination ports, the flags in the case of TCP connections, etc.);

at application level, two generic parameters are considered: the identifier of the user of the application as well as the state of the application;

time information is also included so as to specify when a rule is to be applied.

The actions also have a generic structure (BNF notation):

Action::=<ACTION><ACTION LEVEL><LOG LEVEL>

An action is broken down into three parts. The first indicates whether the communication described by the conditions should be permitted or disallowed. The <ACTION LEVEL> parameter corresponds to the protocol layer in which the action is to be performed. The last part describes the importance accorded to the action control event and allows the classification of the results.

The next paragraph shows how the ACPDL language can be used to write out the expression for an example of an access service. In this example, each item of equipment is identified by its source address <IP_SRC_ADDRESS> and its destination address (IP_DST_ADDRESS). The WWW service is identified by the source port (SRC_PORT) and destination port (DST_PORT). The second command line given in the example is used to disallow connection requests with regard to the WWW port of an internal station.

IF (IP_SRC_ADDRESS=192.165.203.5 255.255.255.255) AND (IP_DST_ADDRESS=0.0.0.0 0.0.0.0) AND (SRC_PORT>1023) AND (DST_PORT=80) THEN PERMIT TRANSP_CONNECTION; IF (IP_SRC_ADDRESS=0.0.0.0 0.0.0.0) AND (IP_DST_ADDRESS=192.165.203.5 255.255.255.255) AND (SRC_PORT=80) AND (DST_PORT>1023) AND (TCP_FLAG<>SYN) THEN PERMIT TRANSP_CONNECTION;

The access control policy is defined by the safety officer by means of a man/machine interface (MMI) 6 of the station 1, using the ACPDL language. It is used to configure the two parts of the controller. However, this policy cannot be used directly by the two access control tools 4, 20/21. The manager 7 is the module which makes it possible to solve this problem by translating the access control policy into configuration commands for the two tools.

This translation procedure can be divided into two main parts. The first is the translation of the policy into three static configurations:

At ATM signaling level, this configuration comprises a description of the communications which need to be controlled. Each communication is described by a set of information elements (IE) and by an action (Permit or Disallow). This configuration is sent to the signaling analyzer 4.

At TCP/IP level the configuration comprises a description of the packets which need to be controlled. This part of the policy may be generic, thus signifying that the rules described therein are not dedicated to a particular ATM connection. This part may also be attached to an ATM connection through the expression of conditions pertaining to connection identifiers.

At cell level, the configuration comprises a description of the cells which need to be controlled. These cells are divided according to the fields which they may contain. The set of values which each field can take is described by a tree. This configuration is sent to the IFT cards.

The second part of the configuration procedure takes place when a connection request is received by the signaling analyzer 4. Once the access control procedure has been carried out, the signaling analyzer 4 sends the manager 7 the information required to perform the dynamic configuration of the IFT cards 20, 21. This dynamic configuration is important since it makes it possible to decrease the size of the configuration information stored in the memory of the IFT cards 5 as compared with a static configuration. This is important since the delay introduced by the IFT cards during the analysis procedure depends on this size. The information provided by the signaling analyzer 4 comprises:

the VPI and VCI (“Virtual Path Identifier”, “Virtual Channel Identifier”) connection identifiers;

the source and destination ATM addresses;

a service descriptor (Classical IP over ATM (CLIP), ATM native applications). When an additional layer is used above the ATM model, the signaling analyzer 4 also provides encapsulation (with or without SNAP/LLC header);

the direction of the communication.

In a CLIP environment, the manager 7 uses the source and destination ATM addresses to find the corresponding IP addresses. This translation is performed by means of a file describing the correspondences between IP and ATM addresses. It can also use an address resolution server (ATMARP).

The manager 7 then tries to find a correspondence between the IP addresses and the generic rules for TCP/IP level access control. The subset of rules obtained is instanced with the IP addresses and associated with the other information (addresses, encapsulation, connection identifiers, direction). This set of information is used by the manager so as to construct the analysis tree which will be used to configure the IFT cards, and is preserved throughout the life of the connection. On connection closure, the manager 7 receives a signal from the signaling analyzer 4 so as to possibly reconfigure the IFT cards 20, 21 by erasing the information relating to the connection. The manager then destroys the information associated with the connection.

The signaling analyzer 4 relies on two functions. The first is the redirection of signaling messages originating from internal and external networks to a filter belonging to the analyzer 4 (FIG. 3). The second is the ability to break up the signaling messages according to the UNI 3.1 specification of the ATM forum (“ATM User-Network Interface Specification, Version 3.1”, ATM Forum, July 1994) and to transmit or to eliminate these messages as a function of the access control configuration provided by the manager 7.

The station 1 is furnished with two ATM interface cards 8, 9 respectively linked to two interfaces 12, 13 of the switch 3 (FIGS. 1, 2 and 5). The other interfaces represented of the switch 3 are denoted 10 (internal network), 11 (external network), 14 and 15 (IFT cards 20 and 21).

In order to redirect the signaling, the ATM switch 3 is configured so as to direct the signaling messages to the station 1 as indicated in FIG. 2. This configuration can be achieved by deactivating the signaling protocol on the interfaces 10, 11, 12 and 13. A virtual channel (VC) must then be constructed between each pair of interfaces for each signaling channel. The signaling channels are for example identified by a virtual channel identifier (VCI) equal to 5.

With the previous configuration, the signaling messages originating from the external network are directed to the interface 13 of the station 1 while the messages originating from the internal network are directed to the interface 12. As indicated in FIG. 3, all the signaling messages are multiplexed by a module 16 of Q93B type belonging to the signaling analyzer 4 and which communicates with the ATM interfaces 8 and 9 through respective modules 17, 18 implementing the SSCOP reliability enhancing protocols. The function of the Q93B module is, in a known manner, to establish, to control and to close the ATM connections. In order to avoid the rejection of signaling messages by the Q93B module, the latter must be modified so as to pass the messages to a filter 19 at the application level without analyzing them. In order to differentiate the filtering carried out on the messages coming from outside from that carried out on the messages coming from inside, the messages are associated with their origin ATM interface. This information is provided to the application package filter 19 by the Q93B module 16.

When signaling messages are received by the signaling analyzer 4, they are decomposed by a message decomposition module 24 into information elements according to the UNI 3.1 specification. The information elements are then decomposed into elementary information such as the addresses, the connection identifiers, the call reference, the quality of service descriptors and the service identifiers. The analyzer 4 then investigates whether the message can be associated with an existing connection by means of the type of message and of the call reference. If the connection is new, a connection descriptor containing this information is constructed. When the connection already exists, the connection descriptor is updated. The connection descriptor is associated with the state of the connection and with the origin interface. It is defined by a connection identifier. The descriptor is then sent to the filter 19 so as to be analyzed.

When the filter 19 receives a connection descriptor, it compares the parameters describing the connection with the set of communications which is described by the access control policy. If a correspondence is found, the filter 19 applies the action associated with the communication. In the converse, it applies the default action which is to disallow the connection. When the action consists of a disallowance, the filter 19 destroys the connection descriptor. In the converse case, it sends the connection descriptor to the message construction module 25. When the connection descriptor indicates that a message CONNECT has been received, a subset of the parameters of the connection descriptor is sent to the manager 7 as indicated hereinabove:

the VPI/VCI connection identifiers, obtained from the IE “Connection Identifier”;

the source and destination ATM addresses, provided by the IEs “Called Party Identifier” and “Calling Party Identifier”;

the service descriptors, obtained from IEs “Broadband Higher Layer Identifier (BHLI)” and “Broadband Lower Layer Identifier (BLLI)”;

the direction, provided by the name of the interface associated with the connection descriptor.

When a connection descriptor indicates the receipt of a message RELEASE_COMPLETE, which completes the releasing of a connection, the connection descriptor is again sent to the manager 7. The communications between the manager 7 and the signaling filter 19 can be carried out in a conventional way by means of a shared memory segment and of signals.

Another functionality provided by the filter 19 is its ability to modify the source ATM address when a communication originates from the internal ATM network, so as to hide the internal topological structure in this network. This functionality is carried out by replacing the source ATM address by the address of the external ATM interface of the station, namely the interface 13.

When the message construction module 25 receives a connection descriptor, it constructs a new signaling message from the information contained in the descriptor. The message is then associated with an output interface and sent to the Q93B module 16. When the state associated with the connection indicates that a message RELEASE_COMPLETE has been received so as to release the connection, the module 16 releases the resources associated with the connection descriptor.

The delay introduced by the signaling analysis procedure has no impact on the normal functioning of the connection since the standardized delays are extremely great (for example 14 seconds between the SETUP and CONNECT messages).

The IFT cards considered here for the implementation of the invention are of the type described in European patent application No. 00400366.1 filed on 9 Feb. 2000 by the applicant. These cards have been designed at the outset for a high throughput routing module (see also EP-A-0 989 502). These cards possess interesting characteristics which mean that they are suited to the device according to the invention.

They allow the analysis of the first cell of each AAL5 frame (“ATM Adaptation Layer No. 5”) and the modification of the corresponding cells as a function of the analysis;

they can operate at the speed of 622 Mbit/s by virtue of a fast and flexible process for analyzing cells;

the delay introduced by the analysis can be bounded and depends on the configuration of the card;

they can be configured dynamically without interrupting the analysis procedure;

they can be integrated into PC type equipment under Solaris.

FIG. 4 describes the information which can be analyzed by the IFT cards 20, 21 in the case of the CLIP protocol (CLIP1) and CLIP without SNAP-LLC encapsulation protocol (CLIP2). The UD and TD fields indicate the start of the data segments for the UDP and TCP protocols, respectively. This signifies that, in the general case, the IFT cards have access to the ATM, IP, TCP, UDP level information and in certain cases the application level information. It should however be noted that the optional fields which may be found in the IP packet are not represented. The presence of these fields (of variable length) may dislodge the TCP or UDP level information into the second ATM cell.

As in the case of signaling, the first part of the access control procedure at cell level consists in redirecting the traffic originating from the internal and external networks to the IFT cards 20, 21. However, in this case, the configuration must preserve the configuration carried out for control of signaling. By way of example, the virtual channels identified by a VCI value equal to 31 are deliberately left free so as to allow the ATM switch 3 to reject the cells belonging to a communication which is to be disallowed. The ATM switch 3 is then configured so as to create a virtual channel for each value of VCI different from 5 and from 31 between each pair of interfaces (10, 14) and (11, 15), as illustrated by FIG. 5.

The IFT cards considered only allow the analysis of unidirectional streams. This signifies that the streams originating from the internal and external networks must be separated. This operation is particularly simple in the case of a physical layer of the Mono Mode fiber type used by the cards since the transmit and receive fibers are physically separated. FIG. 5 shows how the receive and transmit fibers must be connected between the IFT cards and the accessways 14, 15 of the switch 3.

The second part of the access control procedure is the configuring of the IFT cards 20, 21 so that they provide the desired access control service. As indicated previously, this configuration is carried out by the manager 7. The IFT cards have been designed at the outset so as to be managed remotely by several managers. Appropriate software 27 (RPC demon) is then used in the station 2 to serialize the requests addressed to the control circuit 28 (driver) of the cards 20, 21. On the manager 7 side, a library provides access to the configuration functions. This library translates the local calls into remote calls on the station 2. The communications between the two items of equipment are carried out for example through a dedicated Ethernet type network.

The configuration of the cards 20, 21 is based on a description of the communications to be controlled in the form of trees. Each branch of the tree describes the coded value of a binary string, for example of 4 bits, which may be found during the analysis procedure. This procedure consists in traversing the portion of cell to be analyzed in slices of 4 bits serving to access the content of an associative memory of TRIE type included in each IFT card. An analysis tree, constructed on the basis of an access control instruction provided by the manager 7, corresponds to a given stringing together of 4-bit slices found at locations determined by traversing the cell. The root of the tree corresponding to a gatekeeper which must be recognized in order to begin the analysis of the tree. An exemplary analysis is shown diagrammatically in FIG. 6. Complementary information may be associated with a node so as to make it possible to jump from one tree to another or interrupt the analysis allowing modification of the connection identifiers. For further details regarding the operation and configuration of the IFT cards, reference may be made to the aforementioned European patent application No. 00400366.1.

The configuration functions allow the manager 7 to construct, to update and to eliminate these trees while the IFT cards 20, 21 are operating. The translation between the information provided by the procedure for dynamic generation of the cell level access control policy can be carried out as follows:

each possible field is coded by a tree. The values described by the access control policy are then chopped into 4-bit words and allocated to the branches of the tree. The intervals described by several conditions on one and the same field are coded by generating a branch for each possible value in the interval;

the logical AND between two conditions on two different fields is coded as a jump from one tree to another.

The rejection or acceptance action (“DENY” or “ALLOW”) is coded by means of a particular node bringing about the end of the analysis and returning the connection identifier which will be allocated to all the cells of the corresponding AAL 5 frame. The “DENY” action is coded by directing the frame to the unconfigured channel (VCI 31) at the level of the switch 3. The VCI 31 is thus used as wastebin VCI for discarding all the ATM cells which do not comply with the security policy. The “ALLOW” action is coded by leaving the connection identifier unchanged.

The above device constitutes an ATM firewall which can be constructed from existing components. It has the ability to provide an access control service at ATM, IP and transport levels, or even application level, and can reach the speed of 622 Mbit/s on a prototype which has been produced.

Owing in particular to the bounded delay of the access control procedure at cell level, the structure of the device avoids the QoS modifications which are commonplace with conventional firewalls. The device furthermore has the advantages of enjoying a good level of access control at ATM level and a speed of analysis at cell level which is compatible with the throughput of the channel.

To augment the access control capabilities at application level, the manager 7 can program the IFT cards so as to direct the streams produced by the applications with no service quality request to a conventional firewall which analyses these streams thoroughly, by reassembling then resegmenting the IP packets. In this case, the filter 19 of the signaling analyzer 4 is modified so as to provide a quality of service request indication to the manager 7 at the same time as the information indicated previously. The connections established with no QoS commitment are thus designated to the IFT cards 20, 21 by the manager 7, so that the corresponding cells are transferred to the outside firewall and processed according to the desired access control policy.

This same solution can be used to deal with the problem of IP packets possessing options.

The invention has been described above in its preferred application to ATM networks supporting IP networks. It will however be noted that the manager 7 and the filter 19 can be modified so as to provide access control capabilities in respect of other types of use of ATM networks, such as for example LAN, MPOA emulation, or frame relay over ATM, and generally in any network using a signaling channel, such as frame relay, X.25, or even Intserv (which uses RSVP for a signaling), without however being based on lower-layer ATM.

1. A device for access control between ATM networks, comprising signaling analysis means (4) and traffic analysis means (20, 21) linked to an ATM switch (3) configured so as to steer via the signaling analysis means, ATM signaling messages exchanged between internal and external ATM networks, and so as to steer via the traffic analysis means, traffic-bearing ATM cells exchanged between the internal and external networks within the framework of ATM connections established by means of said ATM signaling messages, the device furthermore comprising access control management means (7) for dynamically configuring the traffic analysis means (20, 21) as a function of an access control policy and of information gathered by the signaling analysis means (4) in such a way that the traffic analysis means filter each ATM cell in accordance with the access control policy.

2. The device as claimed in claim 1, in which the access control management means (7), cooperate with the signaling analysis means (4) in such a way as to permit or disallow the establishment of ATM connections in accordance with the access control policy.

3. The device as claimed in claim 1 or 2, in which the signaling analysis means (4) are devised so as to modify the source ATM address indicated in each connection request message emanating from the internal ATM network before forwarding said message to the external network.

4. The device as claimed in claim 3, in which the signaling analysis means (4) are devised so as to replace the source ATM address indicated in each connection request message emanating from the internal ATM network with an ATM address assigned to the signaling analysis means.

5. The device as claimed in any one of claims 1 to 4, in which the access control management means (7) are devised so as to order the traffic analysis means (20, 21) to eliminate elements taken into account in the analysis of cells exchanged within the framework of an ATM connection in response to the detection, by the signaling analysis means (4), of the releasing of said ATM connection.

6. The device as claimed in any one of claims 1 to 5, in which some at least of the ATM cell filterings performed by the traffic analysis means (20, 21) are conditioned by elements defined by the access control management means (7), comprising elements included within the ATM headers of the cells.

7. The device as claimed in claim 6, in which the elements defined by the access control management means (7) for conditioning some at least of the filterings performed by the traffic analysis means (20, 21) furthermore comprise elements included within the headers of packets carried by said cells.

8. The device as claimed in claim 7, in which the elements defined by the access control management means (7) for conditioning some at least of the filterings performed by the traffic analysis means (20, 21) furthermore comprise elements pertaining to a transport protocol associated with the packets.

9. The device as claimed in claim 8, in which said packets are IP packets and said transport protocol is TCP and/or UDP.

10. The device as claimed in any one of claims 7 to 9, in which the elements defined by the access control management means (7) for conditioning some at least of the filterings performed by the traffic analysis means (20, 21) furthermore comprise elements included within headers of units of application layer protocol data transported in the packets.

11. The device as claimed in any one of claims 1 to 10, in which the access control management means (7) are devised so as to order the signaling analysis means (4) and/or the traffic analysis means (20, 21) to apply an access control policy provided according to a unified language for access control operations performed at various protocol levels implemented in said ATM networks.

12. The device as claimed in any one of claims 1 to 11, in which the traffic analysis means (20, 21) are devised so as to transfer to a firewall device ATM cells pertaining to ATM connections designated by the access control management means (7).

13. The device as claimed in any one of claims 1 to 12, in which the traffic analysis means comprise at least one traffic analyzer (20) for the cells going from the internal network to the external network and at least one traffic analyser (21) for the cells going from the internal network to the external network.

14. The device as claimed in any one of claims 1 to 13, in which the access control management means (7) configure the traffic analysis means (20, 21) by providing them with analysis trees corresponding to values of binary strings which may appear at specified locations in ATM cells received from the ATM switch (3), the traffic analysis means (20, 21) being devised so as to detect the binary strings having said values and, in response to this detection for each value of an analysis tree, to accomplish an access control action specified in the access control policy or to pursue the analysis according to a next tree.

15. The device as claimed in claim 14, in which the traffic analysis means (20, 21) comprise at least one associative memory of TRIE type for performing analyses according to a set of trees which is defined dynamically by the access control management means (7).
